(19) United States
(12) Patent Application Publication
(10) Pub. No.: US 2019/0173103 A1
(43) Pub. Date: Jun. 6, 2019

(54) ELECTRODE PLATE AND METHOD FOR MANUFACTURING THE SAME

(71) Applicant: Industrial Technology Research Institute, Hsinchu (TW)

(72) Inventors: Cheng-Hong LIU, Chiayi City (TW); Ching-Ying HUANG, Tainan City (TW); Chih-Chia LIN, Tainan City (TW); Wen-Lin WANG, Kaohsiung City (TW)

(73) Assignee: Industrial Technology Research Institute, Hsinchu (TW)

(21) Appl. No.: 15/888,676

(22) Filed: Feb. 5, 2018

(30) Foreign Application Priority Data
Dec. 6, 2017 (TW) 106142707

(51) Int. Cl. H01M 8/0258; H01M 8/04291

(52) U.S. Cl. CPC H01M 8/0258; H01M 8/04291

(57) ABSTRACT

An electrode plate is provided, which includes a metal base with a flow channel structure disposed between rib portions. A graphite layer wraps the bottom of the flow channel structure, the sidewalls of the flow channel structure, and the rib portions. A hydrophobic layer is disposed on the graphite layer overlying the bottom and the sidewalls of the flow channel structure, and not on the graphite layer overlying the rib portions. The hydrophobic layer on the bottom of the flow channel structure and the hydrophobic layer on the sidewalls of the flow channel structure have a substantially equal thickness.

### CROSS REFERENCE TO RELATED APPLICATIONS

The present application is based on, and claims priority from, Taiwan Application Serial Number 106142707, filed on Dec. 6, 2017, the disclosure of which is hereby incorporated by reference herein in its entirety.

### TECHNICAL FIELD

The technical field relates to an electrode plate of a fuel cell, and in particular it relates to a hydrophobic layer on a flow channel structure and method for manufacturing the same.

### BACKGROUND

Water is produced in a power generation of a fuel cell. If the water that is not exhausted on time (via a channel used for transporting reactant gas and water), flooding may occur, in which the gas becomes blocked to degrade the fuel cell's performance. In a worst-case scenario, the fuel cell may fail. As such, water management in the fuel cell is critical for the proper performance and lifespan of the fuel cell.

Accordingly, a novel design for a flow channel structure is called for to overcome the problem of flooding in the flow channel structure of an electrode plate.

### SUMMARY

One embodiment of the disclosure provides an electrode plate, including a metal base, a graphite layer, and a hydrophobic layer. The metal base has a flow channel structure disposed between a plurality of rib portions. The graphite layer is wrapped on the bottom of the flow channel structure, the sidewalls of the flow channel structure, and the rib portions. The hydrophobic layer is disposed on the graphite layer overlying the bottom and the sidewalls of the flow channel structure. The hydrophobic layer is not disposed on the graphite layer overlying the rib portions. The hydrophobic layer on the bottom of the flow channel structure and the hydrophobic layer on the sidewalls of the flow channel structure have a substantially equal thickness.

One embodiment of the disclosure provides a method for manufacturing an electrode plate, including: providing a metal base, wherein the metal base has a flow channel structure disposed between a plurality of rib portions; wrapping a graphite layer on the bottom of the flow channel structure, the sidewalls of the flow channel structure, and the rib portions; and forming a hydrophobic layer on the graphite layer overlying the bottom and the sidewalls of the flow channel structure. The hydrophobic layer is not disposed on the graphite layer overlying the rib portion. The hydrophobic layer on the bottom of the flow channel structure and the hydrophobic layer on the sidewalls of the flow channel structure have a substantially equal thickness.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1A to 1D show cross-sectional views of an electrode plate during manufacturing in one embodiment of the disclosure;

FIG. 2 shows a perspective view of an attach film, a graphite layer, and a metal base in one embodiment of the disclosure;

FIG. 3 shows a cross-sectional view of an electrode plate in one embodiment of the disclosure;

FIG. 4 shows a cross-sectional view of an electrode plate in one embodiment of the disclosure; and

FIG. 5 shows a comparison of performance curves of fuel cells in Example 1 and Comparative Example 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

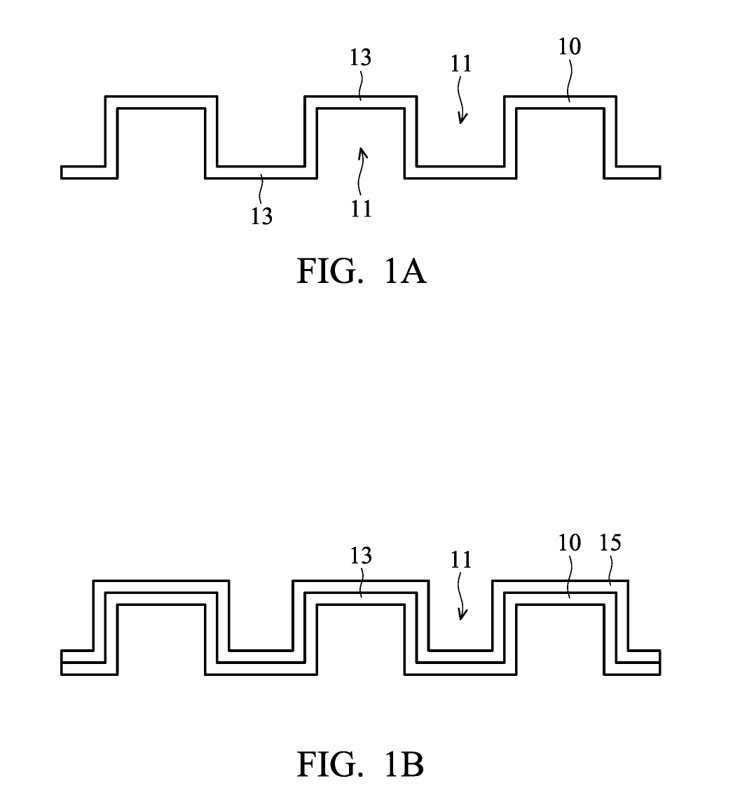

One embodiment of the disclosure provides a method for manufacturing an electrode plate. As shown in FIG. 1A, a metal base 10 is provided. A flow channel structure 11 is disposed between a plurality of rib portions 13 on the surface of the metal base 10. The flow channel structure 11 of the top surface corresponds to the rib portions 13 of the bottom surface, and the rib portions 13 of the bottom surface correspond to the flow channel structure 11 of the bottom surface. It should be understood that the number and the width of the flow channel structure 11 in FIG. 1A are only for illustration, one skilled in the art may choose other numbers or widths of the flow channel structure 11 on the basis of design requirements.

In one embodiment, the metal base 10 can be aluminum, copper, nickel, chromium, or stainless steel. The metal base 10 may have a thickness of 0.03 mm to 10 mm. A metal base 10 that is too thin easily has problems such as insufficient mechanical strength and mold process cracking. A metal base 10 that is too thick cannot achieve a light-weight, thin-shape, and dense fuel cell, such that the power density of the fuel cell cannot be improved. In one embodiment, the flow channel structure 11 can be Z-shaped, zigzag-shaped, or a plurality of parallel straight lines. In one embodiment, the flow channel structure 11 may have a depth (e.g. the distance between the top surface of the rib portions 13 and the bottom of the flow channel structure 11) of about 0.1 mm to 1 mm. A flow channel structure that is too shallow easily results in an insufficient reactant flow. A flow channel structure that is too deep easily causes the flooding problem and the mold process cracking.

A graphite layer 15 is then formed to wrap on the bottom of the flow channel structure 11, the sidewalls of the flow channel structure 11, and the rib portions 13, as shown in FIG. 1B. In one embodiment, the steps of wrapping the graphite layer 15 may include: a first adhesion layer (not shown) is formed on the metal base 10, graphite powder are placed on the first adhesion layer, and the first adhesion layer and the graphite powder are laminated to form the graphite layer 15. For details of the graphite layer 15 and the method for manufacturing the same, Taiwan Patent No. 1482349 can be referred to, and the related description is not repeated here. Alternatively, the graphite layer 15 can be formed on the bottom of the flow channel structure 11, the sidewalls of the flow channel structure 11, and the rib portions 13 by chemical vapor deposition. If the chemical vapor deposition is adopted, the first adhesion layer can be omitted.

Subsequently, a hydrophobic layer 19 is formed on the graphite layer 15 overlying the bottom and the sidewalls of the flow channel structure 11, and the hydrophobic layer 19 is not disposed on the graphite layer 15 overlying the rib portion 13. The hydrophobic layer 19 on the bottom of the flow channel structure 11 and the hydrophobic layer 19 on the sidewalls of the flow channel structure 11 have a substantially equal thickness. In one embodiment, the hydrophobic layer 19 can be polyethylene, polypropylene, fluorinated ethylene propylene copolymer, poly(vinylidene difluoride), or a blend thereof. In one embodiment, the polymer of the hydrophobic layer 19 may have a weight average molecular weight of 1000 to 20000. A weight average molecular weight of the polymer that is too low results in a melting point that is too low of the polymer, which is not suitable for the working temperature of the fuel cell. A weight average molecular weight of the polymer that is too high needs high-temperature processing, which is not economical. In one embodiment, the hydrophobic layer 19 has a thickness of 1 micrometer to 50 micrometers. A hydrophobic layer that is too thin makes it difficult to form a structure with a rough surface. A hydrophobic layer that is too thick easily restricts the size of the existing flow channel, thereby lowering the fuel cell performance. In one embodiment, the surface of the hydrophobic layer 19 and water may have a contact angle of 100° to 160°. The contact angle that is too small cannot achieve the desired hydrophobic effect for the hydrophobic layer 19.

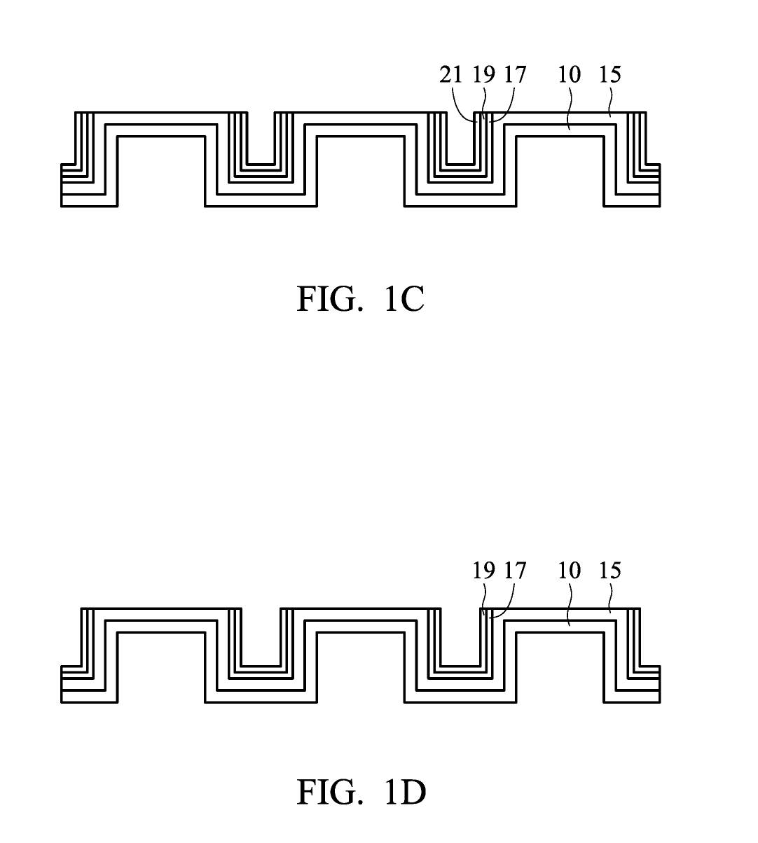

The formation of the hydrophobic layer 19 may include providing an attach film 16, which includes a three-layered structure of a second adhesion layer 17, the hydrophobic layer 19, and the release layer 21. The attach film 16 has openings 18 to correspond to the rib portions 13 of the metal base 10, as shown in FIG. 2. Note that the shape of the openings 18 of the attach film 16 and the shape of the rib portions 13 of the metal base 10 in FIG. 2 are only for illustration, one skilled in the art may design the shape of the rib portions 13 on the basis of requirement, and pattern the attach film 16 according to the locations of the rib portions 13. As such, the attach film 16 may have appropriate openings 18. In one embodiment, the release layer 21 can be poly(ethylene terephthalate) (PET) or another thermoplastic polymer having a melting point higher than that of the hydrophobic layer 19.

Thereafter, a first hot-press step is performed to attach the attach film 16 onto the graphite layer 15 overlying the bottom and the sidewalls of the flow channel structure 11, and the graphite layer 15 on the rib portions 13 is exposed, as shown in FIG. 1C. The second adhesion layer 17 is mainly used for corresponding to the first adhesion layer (not shown) in the graphite layer 15. In one embodiment, the second adhesion layer 17 can be ethylene-vinyl acetate (EVA) or another thermoplastic polymer having a melting point lower than that of the hydrophobic layer 19. The second adhesion layer 17 is utilized to reduce the temperature, the pressure, and the period of the hot-press step because the first adhesion layer cannot sustain a hot-press temperature that is too high, a hot-press pressure that is too high, or a hot-press period that is too long. In this embodiment, the hydrophobic layer 19 and the graphite layer 15 are adhered by the second adhesion layer 17. The release layer 21 is then removed, and a second hot-press step is performed on the hydrophobic layer 19 to form an electrode plate, as shown in FIG. 1D. In this embodiment, the first hot-press step is performed at a temperature of 40° C. to 60° C. under a pressure of 10 kg/cm² to 50 kg/cm² for a period of 30 seconds to 60 seconds. The attach film 16 is easily peeled from the graphite layer 15 due to a temperature that is too low, a pressure that is too low, or a period that is too short of the first hot-press step. The first adhesion layer in the graphite layer 15 may be damaged by a temperature that is too high, a pressure that is too high, or a period that is too long of the first hot-press step, such that the graphite layer 15 is easily peeled from the metal base 10. In this embodiment, the second hot-press step is performed at 90° C. to 140° C. under a pressure of 10 kg/cm² to 50 kg/cm² for a period of 30 seconds to 90 seconds. The hydrophobic layer 19 is easily peeled from the graphite layer 15 due to a temperature that is too low, a pressure that is too low, or a period that is too short of the second hot-press step. The first adhesion layer in the graphite layer 15 may be damaged by a temperature that is too high, a pressure that is too high, or a period that is too long of the second hot-press step, such that the graphite layer 15 is easily peeled from the metal base 10. In this embodiment, the hydrophobic layer 19 is disposed between the second adhesion layer 17 and the release layer 21 in the attach film 16, and the second adhesion layer 17 is disposed between the hydrophobic layer 19 and the graphite layer 15 after the first hot-press step.

Alternatively, the graphite layer 15 is directly deposited on the metal base 10, such that the second adhesion layer 17 in the attach film 16 can be omitted. As such, the attach film 16 is attached onto the graphite layer 15 overlying the bottom and the sidewalls of the flow channel structure 11 by a first hot-press step under a higher pressure at a higher temperature for a longer period, and the graphite layer 15 overlying the rib portions 13 is exposed. In this embodiment, the hydrophobic layer 19 adheres directly to the graphite layer 15. Subsequently, the release layer 21 is removed, and a second hot-press step is performed on the hydrophobic layer 19. In this embodiment, the first and second adhesion layers are omitted, and the first and second hot-press steps can be performed for a longer period at a higher temperature under a higher pressure than the period, the temperature, and the pressured of the first and second hot-press steps with the first and second adhesion layers in the previous embodiment, thereby increasing the adhesion between the hydrophobic layer 19 and the graphite layer 15.

Whatever the first and the second adhesion layer exist or not, the mold used in the second hot-press step may have a rough surface to contact the surface of the hydrophobic layer, giving the hot-pressed hydrophobic layer 19 a correspondingly rough surface. The rough surface of the hydrophobic layer may have a roughness (Ra) of 0.1 micrometers to 25 micrometers. The rough surface of the hydrophobic layer 19 may increase the contact angle between the hydrophobic layer and water, thereby further increasing the hydrophobic effect of the hydrophobic layer 19. After the above steps, an electrode plate is completed. The electrode plate may serve as a monopolar plate at an anode side or a cathode side of the fuel cell. The side including the graphite layer 15 and the hydrophobic layer 19 (e.g. the top surface of the metal base 10) of the monopolar plate may be in contact with a gas diffusion layer, and the other side (e.g. the bottom surface of the metal base 10) of the monopolar plate may be in contact with the end plate and the current collector.

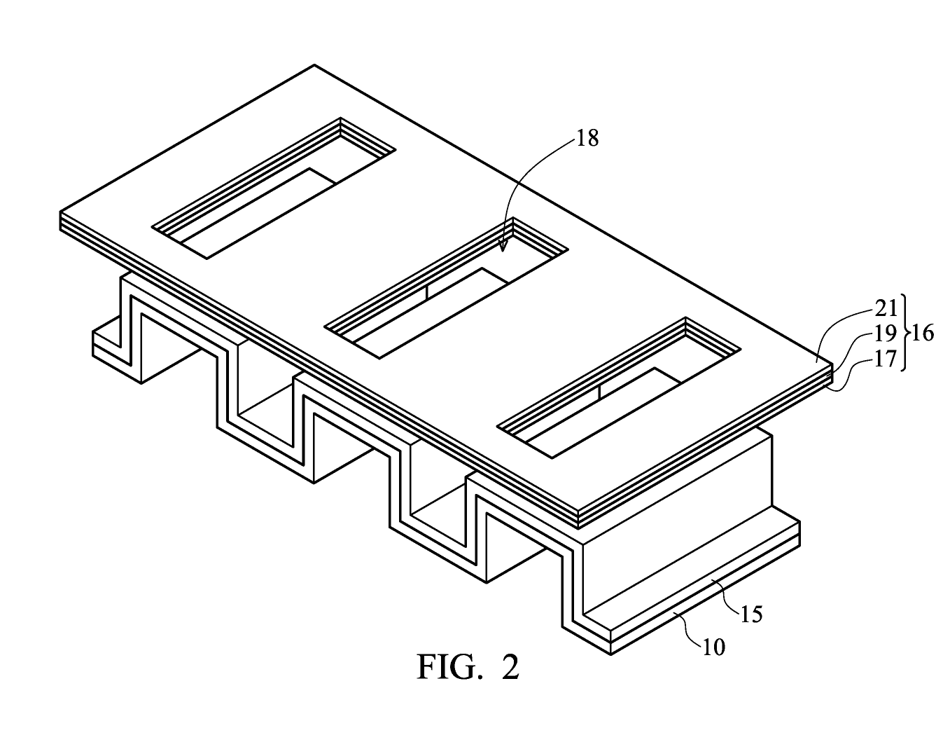

Alternatively, the top surface of the metal base 10 includes the flow channel structure 11 disposed between the rib portions 13, and the bottom surface of the metal base 10 is flat, as shown in FIG. 3. In this embodiment, the graphite layer 15 and the hydrophobic layer 19 are disposed on the top surface of the metal base 10 by the above method, and the related description is not repeated here. The structure in FIG. 3 may serve as a monopolar plate, the side including the graphite layer 15 and the hydrophobic layer 19 (e.g. the top surface of the metal base 10) of the monopolar plate may be in contact with the gas diffusion layer, and the other side (e.g. the bottom surface of the metal plate 10) of the monopolar plate may be in contact with the end plate and the current collector.

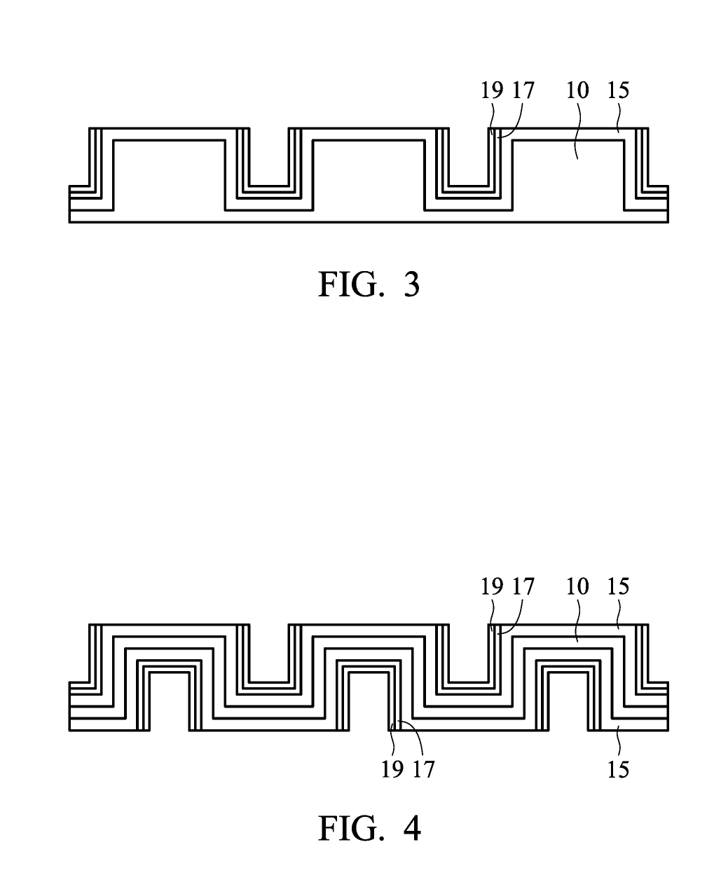

In one embodiment, the graphite layer 15 and the hydrophobic layer 19 can be also formed on the bottom surface of the metal base 10, as shown in FIG. 4. The graphite layers 15 on the top surface and the bottom surface of the metal base 10 can be simultaneously formed, and the hydrophobic layers 19 on the top surface and the bottom surface of the metal base 10 can be simultaneously formed. Both the top surface and the bottom surface of the metal base 10 have the flow channel structures in FIG. 4, such that the metal base 10 may serve as a bipolar plate, and the top surface and the bottom surface of the metal base may be in contact with the gas diffusion layers.

In general, the fuel cell may sequentially include an anode end plate, an anode current collector, an anode monopolar plate, a stack of number n (n is equal to or greater than 0, and the stack includes anode gas diffusion layer, membrane electrode assembly, cathode gas diffusion layer, and bipolar plate), an anode gas diffusion layer, membrane electrode assembly, cathode gas diffusion layer, cathode monopolar plate, cathode current collector, and cathode end plate. The anode monopolar plate and the cathode monopolar plate can be the monopolar plates as shown in FIGS. 1D and 3, and the bipolar plate can be the bipolar plate as shown in FIG. 4. Because the flow channel structures of the monopolar plate and the bipolar plate in the disclosure include the hydrophobic layer, which may efficiently prevent the flooding problem in the flow channel structure in the conventional electrode plates. Because the hydrophobic layer 19 in the disclosure is formed by hot press, the hydrophobic layer 19 on the bottom of the flow channel structure 11 and the hydrophobic layer 19 on the sidewalls of the flow channel structure 11 have a similar thickness and a similar hydrophobic effect. If the hydrophobic layer is formed by coating, the hydrophobic layer 19 on the bottom of the flow channel structure 11 and the hydrophobic layer 19 on the sidewalls of the flow channel structure 11 cannot have a similar thickness due to factors of gravity, drying, and the like.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Comparative Example 1

According to Taiwan Patent No. 1482349, a metal base having a flow channel structure between a plurality of rib portions was provided. A graphite layer was formed on the surface of the metal substrate. In this example, the flow channel structure had a width of 0.7 mm and a depth of 0.7 mm, and the graphite layer had a thickness of 40 micrometers. The graphite layer was formed in the following steps. An adhesion layer with a thickness of 0.5 to 100 micrometers was formed on the metal base, which included 20 to 80 vol % of carbon powder (nature flake graphite powder, commercially available from HOMYTECH CO., LTD.) and 80 to 20 vol % of polymer binder (vinyl ester resin, commercially available from Swancor). Graphite powder was placed on the adhesion layer, and then laminated into the adhesion layer by a mold to form a dense graphite layer. This pressing step was performed under a pressure of 500 kg/cm². As such, a graphite layer with a thickness of 10 micrometers to 300 micrometers was formed on the metal base to complete a monopolar plate. In the monopolar plate, the graphite layer was disposed on only one side of the metal base.

Comparative Example 1 not only formed the monopolar plate but also a bipolar plate. The steps for forming the bipolar plate were similar to those for forming the monopolar plate, and the difference being that the graphite layers were formed on two sides of the metal base in the bipolar plate.

(1) An anode current collector (a gold plated copper sheet, commercially available from JVE Co., Ltd.) was placed on an anode end plate (a hard anodized aluminum alloy, commercially available from JVE Ltd. Co.). (2) There was a prepared monopolar plate (serving as an anode plate) on the anode current collector. (3) An anode gas diffusion layer (SGL) was placed on the anode plate, and the graphite layer on the rib portions of the anode plate was in contact with the anode gas diffusion layer. (4) A membrane electrode assembly (GORE) was placed on the anode gas diffusion layer. (5) A cathode gas diffusion layer (SGL) was placed on the membrane electrode assembly, and the prepared bipolar plate was placed on the cathode gas diffusion layer. (6) Another prepared bipolar plate was placed on the prepared bipolar plate in step (5). Steps (3) to (6) were repeated to achieve the desired cell number. In Comparative Example 1, the cell number was three. (7) An anode gas diffusion layer was then placed on the bipolar plate, a membrane electrode assembly was placed on the anode gas diffusion layer, and a cathode gas diffusion layer was placed on the membrane electrode assembly. (8) The monopolar plate (serving as the cathode plate) was placed on the cathode gas diffusion layer. The graphite layer on the rib portions of the cathode plate was in contact with the cathode gas diffusion layer. (9) A cathode current collector (a gold plated copper sheet, commercially available from JVE Ltd. Co.) was placed on the cathode plate. (10) A cathode end plate (a hard anodized aluminum alloy, commercially available from JVE Ltd. Co.) was placed on the cathode current collector. The full cell was locked and fixed by an assembly pressure of 3 MPa to 8 MPa to complete a fuel cell testing device.

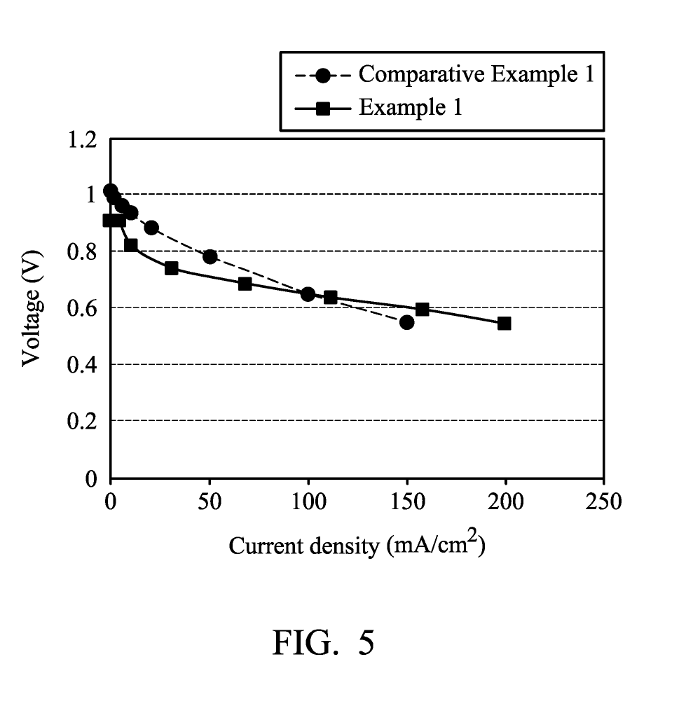

The performance of the fuel cell was tested under the following conditions. The mass flows of the gases were controlled by a mass flow controller (MFC), in which hydrogen and air had a flow ratio of 1.5/2.5. The temperature of the fuel cell was controlled at 60° C. to 80° C., and the relative humidity of the cathode and the anode was controlled to 40% to 100%. The output voltage and current of the fuel cell were measured by an electrical load device, which were recorded by a computer to plot the relationship between voltage and current density, such as the performance curve of the fuel cell as shown in FIG. 5.

### Example 1

According to Taiwan Patent No. 1482349, a metal base having a flow channel structure between a plurality of rib portions was provided. A graphite layer was formed on the surface of the metal substrate. In this example, the flow channel structure had a width of 0.7 mm and a depth of 0.7 mm, and the graphite layer had a thickness of 40 micrometers. The graphite layer was formed in the following steps. An adhesion layer with a thickness of 0.5 to 100 micrometers was formed on the metal base, which included 20 to 80 vol % of carbon powder (nature flake graphite powder, commercially available from HOMYTECH CO., LTD.) and 80 to 20 vol % of polymer binder (vinyl ester resin, commercially available from Swancor). Graphite powder was placed on the adhesion layer, and then laminated into the adhesion layer by a mold to form a dense graphite layer. This pressing step was performed under a pressure of 500 kg/cm². As such, a graphite layer with a thickness of 10 micrometers to 300 micrometers was formed on the metal base.

A three-layered attach film was provided, which included a release layer (PET, commercially available from 3M), a hydrophobic layer (LDPE, commercially available from KAO-CHIA PLASTICS Co., Ltd.), and an adhesion layer (EVA, commercially available from KAO-CHIA PLASTICS Co., Ltd.). The attach film was patterned according to the rib portions of the metal base, such that the patterned attach film had openings corresponding to the rib portions of the metal base. The attach film was placed on the graphite layer overlying the metal base, and then hot-pressed onto the graphite layer overlying the bottom and the sidewalls of the flow channel structure. The hot-press step was performed at a temperature of 60° C. under a pressure of 12 kg/cm² for a period of 60 seconds. The release layer was then removed, and the hydrophobic layer was hot-pressed again. The further hot-press step was performed at a temperature of 110° C. under a pressure of 12 kg/cm² for a period of 60 to 100 seconds. After the above steps, a hydrophobic layer with a thickness of 10 micrometers was formed on the graphite layer overlying the bottom and the sidewalls of the flow channel structure of the metal base, thereby completing a monopolar plate. In the monopolar plate, the graphite layer and the hydrophobic layer were disposed on the top surface of the metal base.

Example 1 not only formed the monopolar plate but also a bipolar plate. The steps for forming the bipolar plate were similar to those for forming the monopolar plate, the difference being that the graphite layers and the hydrophobic layers were formed on two sides of the metal base in the bipolar plate.

A fuel cell in Example 1 was assembled by the steps in Comparative Example 1, with the difference in Example 1 being that the monopolar plate and the bipolar plate included the graphite layer(s) and the hydrophobic layer(s). In addition, the cell number in Example 1 was ten. The performance curve of the fuel cell in Example 1 was obtained by a method similar to that in Comparative Example 1, as shown in FIG. 5.

In general, the voltages versus different current densities of the fuel cell in Example 1 (with a cell number of 10) should be lower than the voltages versus different current densities of the fuel cell in Comparative Example 1 (with a cell number of 3), because the higher cell number should result in a higher ohmic impedance. However, the fuel cell in Example 1 had higher voltages versus higher current densities. The fuel cell often produces a large amount of water at a high current density. Obviously, the hydrophobic layer in Example 1 was beneficial to exhaust water for enhancing the fuel cell performance.

After repeating the electric cycle test, the fuel cell was dissembled to check the appearance of the monopolar plate and the bipolar plate. Obviously, the hydrophobic layers of the monopolar plate and the bipolar plate were not peeled.

### Example 2

Example 2 was similar to Example 1, with the difference in Example 2 being that, after the release layer was removed, the hydrophobic layer was hot-pressed by a mold with a rough surface, giving the hot-pressed hydrophobic layer a correspondingly rough surface. The contact angle between water droplet and different surfaces were measured by a contact angle meter. The surface of the meal base and water had a contact angle of 63°. The surface of the graphite layer wrapping the metal base in Comparative Example 1 and water had a contact angle of 88°. The surface (planar surface) of the hydrophobic layer on the bottom and the sidewalls of the flow channel structure in Example 1 and water had a contact angle of 100°. The surface (rough surface) of the hydrophobic layer on the bottom and the sidewalls of the flow channel structure in Example 2 and water had a contact angle of 140°. Accordingly, hot-pressing the hydrophobic layer by a mold with a rough surface could increase the surface roughness of the hydrophobic layer, thereby increasing the contact angle between the hydrophobic layer and water. Therefore, the hydrophobic effect of the hydrophobic layer could be increased further to improve the fuel cell performance.

### Comparative Example 2

A metal base having a flow channel structure disposed between the rib portions in Comparative Example 1 was provided, which was wrapped by the graphite layer. Hydrophobic molecule polytetrafluoroethylene (PTFE) was spray coated or dip coated on the graphite layer overlying the bottom and the sidewalls of the flow channel structure, and then baked to form a hydrophobic layer. However, the coated (not hot-pressed) hydrophobic layer had a non-uniform thickness. For example, the hydrophobic layer on the bottom of the flow channel structure was thicker than the hydrophobic layer on the sidewalls of the flow channel structure. In addition, the hydrophobic layer could not completely wrap (e.g. partially expose) the sidewalls of the flow channel structure due to gravity.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An electrode plate, comprising:
a metal base having a flow channel structure disposed between a plurality of rib portions;
a graphite layer wrapped on a bottom of the flow channel structure, sidewalls of the flow channel structure, and the rib portions; and
a hydrophobic layer disposed on the graphite layer overlying the bottom and the sidewalls of the flow channel structure, and not disposed on the graphite layer overlying the rib portions,
wherein the hydrophobic layer on the bottom of the flow channel structure and the hydrophobic layer on the sidewalls of the flow channel structure have a substantially equal thickness.

2. The electrode plate as claimed in claim 1, wherein the hydrophobic layer comprises polyethylene, polypropylene, fluorinated (ethylene propylene) copolymer, or poly(vinylidene difluoride).

3. The electrode plate as claimed in claim 1, wherein the surface of the hydrophobic layer and water have a contact angle of 100° to 160°.

4. The electrode plate as claimed in claim 1, wherein the hydrophobic layer has a rough surface, and the rough surface has a roughness (Ra) of 0.1 micrometers to 25 micrometers.

5. A method for manufacturing an electrode plate, comprising:
providing a metal base, wherein the metal base has a flow channel structure disposed between a plurality of rib portions;
wrapping a graphite layer on the bottom of the flow channel structure, sidewalls of the flow channel structure, and the rib portions; and
forming a hydrophobic layer on the graphite layer overlying the bottom and the sidewalls of the flow channel structure, wherein the hydrophobic layer is not disposed on the graphite layer overlying the rib portion,
wherein the hydrophobic layer on the bottom of the flow channel structure and the hydrophobic layer on the sidewalls of the flow channel structure have a substantially equal thickness.

6. The method as claimed in claim 5, wherein the hydrophobic layer comprises polyethylene, polypropylene, fluorinated (ethylene propylene) copolymer, or polyvinylidene difluoride.

7. The method as claimed in claim 5, wherein the step of wrapping the graphite layer comprises:
forming a first adhesion layer on the metal base;
placing graphite powder on the first adhesion layer; and
laminating the graphite powder and the first adhesive layer to form the graphite layer.

8. The method as claimed in claim 5, wherein the step of forming the hydrophobic layer comprises:
providing an attach film, wherein the attach film includes the hydrophobic layer and a release layer, and the attach film has openings corresponding to the rib portions of the metal base;
performing a first hot-pressing to attach the attach film onto the graphite layer overlying the bottom and the sidewalls of the flow channel structure, and exposing the graphite layer overlying the rib portions;
removing the release layer; and
performing a second hot-pressing on the hydrophobic layer.

9. The method as claimed in claim 5, wherein the surface of the hydrophobic layer and water have a contact angle of 100° to 160°.

10. The method as claimed in claim 8, wherein the second hot-pressing step utilizes a mold with a rough surface to make the hydrophobic layer have a corresponding rough surface, and the rough surface of the hydrophobic layer has a roughness (Ra) of 0.1 micrometers to 25 micrometers.

11. The method as claimed in claim 8, wherein the first hot-pressing step is performed at 40° C. to 60° C. under a pressure of 10 kg/cm² to 50 kg/cm² for a period of 30 seconds to 60 seconds.

12. The method as claimed in claim 8, wherein the second hot-pressing step is performed at 90° C. to 140° C. under a pressure of 10 kg/cm² to 50 kg/cm² for a period of 30 seconds to 90 seconds.

13. The method as claimed in claim 8, wherein the attach film further includes a second adhesion layer, the hydrophobic layer is disposed between the second adhesion layer and the release layer in the attach film, and the second adhesion layer is disposed between the hydrophobic layer and the graphite layer after the first hot-pressing step.
